(19) United States
(12) Patent Application Publication
(10) Pub. No.: US 2016/0292741 A1
(43) Pub. Date: Oct. 6, 2016

(54) GROUP MONITORING AND COMMUNICATION SYSTEM

(71) Applicant: Richard William Rankin, Belfast (GB)

(72) Inventor: Richard William Rankin, Belfast (GB)

(21) Appl. No.: 14/678,988

(22) Filed: Apr. 5, 2015

(51) Int. Cl. G06Q 30/02; G06F 3/0488; H04W 4/08; G06F 3/0484; H04W 4/02; G06T 13/80; G06F 3/0481

(52) U.S. Cl. CPC G06Q 30/0261; G06T 13/80; G06F 3/04883; G06F 3/0481; G06F 3/04842; H04W 4/021; H04W 4/08

(57) ABSTRACT

A system for monitoring/confirming the location of and communicating with a group of user devices or individual members thereof is generally represented by reference numeral 1. The system 1 comprises a mobile application or website executable on a mobile device 2 such as a smartphone. The mobile application enables users to associate mobile devices to form groups 3 of such devices. The system 1 also has a location confirmation member in the form of a Bluetooth low energy beacon and/or sonic signal beacon 4 and/or GPS system 15 for determining which mobile devices 2 associated with a formed group 3 are present in a pre-defined location or area 5, and given this information communicates collectively or individually with those mobile devices 2 which are associated with a formed group 3 and have been determined as present in the pre-defined location or area 5 at the time of said communication.

The present invention relates to a system for facilitating the rewarding of group purchasing of products and/or services and in particular to a secure and/or accountable system for facilitating the rewarding of group purchasing of products and/or services.

Systems exist which permit users to form social groups and arrange to attend events with group members. However, the process is entirely for the purpose of organisation and communication between the group members and even though large groups of individuals are an attractive customer base for many retail and entertainment businesses, there is no way in which a group of individuals can currently leverage its group attendance at an event or a business to their advantage.

Systems also exists wherein individuals can be communicated with based on their location and provided with offers or advertising if they are present in a particular location. However, this individual communication does not incentivise consumers purchase as a group, thus increasing custom and sales for vendors and businesses.

In addition to permitting the formation of groups, technology exists in the form of GPS which allows members of groups to confirm their location via a GPS enabled device. However, the accuracy of GPS confirmation is heavily dictated by the location being confirmed and the strength of the signal received by the device meaning that businesses would be relaying on trust alone that customers were not simply claiming to be present. In addition, ways exist to fake a GPS defined location which would leave a system of reward for attendance based on this technology only open to obvious fraud.

It is the object of this invention to mitigate the problem of facilitating the forming of user groups, all or some of whom may attend an event, location, or business and leverage their group size to avail of discounts or offers on products or services offered by the event, venue, or business, ensuring that the event, venue, or business can confirm beyond a reasonable doubt that the group members receiving the discounts or offers are actually in attendance at the event, venue, or business.

Accordingly, the present invention provides a system for monitoring/confirming the location of, and communicating with, a group of user devices or individual members thereof, the system comprising a user interaction interface executable on each user device, the user interaction means enabling users to associate user devices to form groups of user devices, a location confirmation means for determining which user devices associated with a formed group are present in a pre-defined location or area, and means for communicating collectively or individually with those user devices which are associated with a formed group and have been determined as present in the pre-defined location or area at the time of said communication.

Ideally, the user device is one or more of a computer, mobile phone, tablet device, or any such device.

Preferably, the user interaction means is a website, a web application, a mobile application or any other such interaction means capable of allowing interaction through a user device.

Ideally, the user interacts with the user interaction means via one or any combination of a user device keypad, keyboard, mouse, touchscreen, or trackpad.

Preferably, the location confirmation means employs one or any combination of GPS, Bluetooth low energy, sonic signals, or near filed communication (NFC).

Preferably, in one particular embodiment, the location confirmation means employs at least a combination of Bluetooth low energy signals and sonic signals.

Ideally, the location confirmation means is a Bluetooth Low energy beacon also capable of transmitting a sonic signal receivable by a user device.

Preferably, in one particular embodiment, the location confirmation means employs at least a combination of Bluetooth low energy signals and GPS.

Advantageously, the confirmation of location is not wholly dependent on the GPS signal of a user device.

Ideally, the presence of each user device in the pre-defined location or area is periodically confirmed by communication between the user device and location confirmation means at regular time intervals.

Preferably, the time intervals are adjustable.

Preferably, the location confirming means emits a signal which is receivable by the user device.

Ideally, the user device, upon receipt of a signal from the location confirming means, is confirmed as present in the pre-defined location or area.

Ideally, the user interaction means is in operable communication with a database for storing information with regards to groups a user device is associated with and presence of the user device in a pre-defined location or area.

Preferably, the user interaction means is in operable communication with a software program, the software program having one or more algorithms for deciding and/or controlling which communication a particular user device or group thereof will receive based on information stored in the database.

Ideally, the software program is locatable on a server or in the cloud.

Preferably, the location confirmation means can be configured to only confirm the presence of user devices within a pre-defined area around said location confirmation means.

Ideally, the content of the communication with a group of user devices or individual member thereof will be dependent on the number of members of said associated group of user devices which are present in the pre-defined location or area.

Preferably, the content of the communication with a group of user devices or individual member thereof is a discount or offer, the value of which increases depending on the number of members of said associated group of user devices which are present in the pre-defined location or area.

Ideally, the means of communication with a group of user devices or individual member thereof is via a message system built into the user interaction means, by email, by social network messaging, by a message or document transmitted by the location confirmation means, by a smartphone notification, or by any other form of suitable messaging means.

Ideally, the users will form a group by grouping their respective user devices via the user interaction means and register their intent to attend a venue at some point in the future, the venue comprising the predefined location or area.

Ideally, information on the group, it's members, and location of the pre-defined location or area are stored in the database.

Preferably, upon attending the venue, each user is confirmed in attendance by the location confirmation means and receives a communication, the content of which will be dependent on the group size confirmed present, the user can then use said communication to receive a discount or offer on the product or service offered at the venue in question.

Ideally, throughout a users attendance at a pre-defined location or area, they receive periodic communications should they be confirmed to be in continued attendance, the content of the communication being dependent on the group size confirmed present, the user can then use said communication to receive a discount or offer on the product or service offered at the venue in question.

Alternatively, the users can form a group and indicate their intention to attend an unspecified event, after which organisers of an event can contact group members in order to encourage attendance at the organisers particular event.

Ideally, organisers of events, owners of businesses, or other such parties can list events, offers, venue information, images or other such information which users can access through the user interaction means.

Preferably, organisers of events, owners of businesses, or other such parties can associate their event, business, or venue, with a pre-defined location or area such that users and groups of users of the system can be confirmed in attendance at an event, business premises or venue.

Ideally, organisers of events, owners of businesses, or other such parties associate their event, business, or venue, with a pre-defined location or area by one or any combination of input of GPS coordinates in to the system, installation of a Bluetooth Beacon, installation of a beacon capable of sonic signal communication, or installation of an NFC device.

Preferably, users can associate their group with a listed event, offer, or venue.

Ideally, the user device is a mobile device such as a smartphone having an application executable thereon.

Ideally, an initial user can form a group and invite one or more other users to join the group via the user interaction means with or without the aid of email and/or text and/or social media.

Preferably, members of a group can invite further users to join a group via the user interaction means with or without the aid of email and/or text and/or social media.

Ideally, should an individual be invited to join a group who does not have the application executable on their mobile device, the user will be contacted via text (SMS message), email, or social media message and instructed to install the application on their mobile device so that they may accept an invitation to the group.

Preferably, the system permits members of a group to communicate with each other via a messaging system and/or post photos to an area within the user interaction means.

Ideally, the system permits advertisers to contact users of the system to offer products or services.

Preferably, the system has means for forwarding one or more communications to all or part of the user base at any time, such communications including but not limited to marketing, advertising, or the like.

Ideally, the system has means for forwarding a communication to a user who had been confirmed as present at the pre-defined location but had also been confirmed as having left the pre-defined location, the communication being deliverable a pre-set time after the user has left the pre-defined location.

Ideally, once an offer is received by a user it is presented for redemption to a vendor.

Preferably, an offer received by a user is presented to a vendor on the screen of the user device.

Ideally, the offer is presented to a vendor who has means of verifying the offer as valid.

Preferably, the means of verifying the offer is valid comprises a vendor interacting with the offer on the screen of the user device.

Ideally, the means of verifying the offer is valid comprises a vendor pressing on the user device screen or button displaying the offer and initiating an animation or security code display.

Preferably, after the vendor has pressed on the user device screen or button displaying the offer and initiated an animation or security code display, the animation or security code display cannot be re-initiated.

Advantageously, an issued offer can only be utilized once as the animation or security code display will not initiate upon subsequent attempts to use the offer ensuring that the offer can only be redeemed once.

Preferably, the group of user devices is a group of smartphones or other mobile devices having a mobile application executable thereon acting as the user interaction means and enabling users to associate individual user devices to form groups of user devices and associate said group with a business, event, or venue who intend to communicate with and/or provide offers to users who attend their business, event, or venue as a group.

Ideally, the mobile application permits businesses, events, or venues who intend to communicate with and/or provide offers to users who attend their business, event, or venue as a group to list their businesses, events, or venues on the mobile application such that users can search and/or view said businesses, events, or venues and their associated offers.

Preferably, the businesses, events, or venues can specify the offer or offers available, the time of the event, and any other relevant information.

Preferably, once a user has located a business, event, or venue that they wish to attend, they may create a group and associate said group with the business, event, or venue, and invite other users to join the group.

Ideally, any group member may invite additional users to join the group.

Preferably the location confirmation means is one or both of GPS and Bluetooth low energy beacon, these technologies working alone or together to determine which user devices associated with a formed group are present in a pre-defined location or area, the predefined location or area being associated with a business, event, or venue who intend to communicate with and/or provide offers to users who attend their business, event, or venue as a group.

Ideally, the means for communicating collectively or individually with user devices which are associated with a formed group and have been determined as present in the pre-defined location or area at the time of said communication is via the mobile application which displays an automatically generated offer, the value of which is based on the number of user devices associated with a formed group who are confirmed as currently present at the pre-defined location or area.

Preferably, the system periodically assesses the number of user devices associated with a formed group who are confirmed as currently present at the pre-defined location or area and generates a new offer based on this information, the new offer being the same, of greater value, or of lesser value depending on whether the number of user devices associated with a formed group who are confirmed as currently present at the pre-defined location has remained the same, increased, or decreased since the previous offer.

Ideally, the system provides predefined bands of offers which specify different offer levels and the number of user devices associated with a formed group who are confirmed as currently present at the pre-defined location which is required to attain a particular offer level.

Preferably, once a user receives an offer, the user presents the offer to a vendor at the business, event, or venue and the vendor presses on the screen of the mobile device initiating an animation or revealing a code or other such verification.

Ideally, the initiation of the animation or revealing of the code or other such verification means can only be carried out once per offer, or a number of times as specified by the business, event, or venue.

Preferably, the vendor, once satisfied that the offer is valid, applies the offer or discount to the goods and/or services purchased by the user.

Accordingly, the present invention provides a method preformed by a system for monitoring/confirming the location of and communicating with a group of user devices or individual members thereof, the user devices being mobile devices having a mobile application executable thereon, the method comprising a user forming a group, and inviting other users to join the group, any invited user who joins the group may also invite additional users to join the group, the group being associated with a business, event, or venue who intend to communicate with and/or provide offers to users who attend their business, event, or venue as a group either whilst forming the group or thereafter, the businesses, events, and/or venues being viewable and/or searchable by users via the mobile application, the group or part thereof attending the business, event, or venue and each member of the group being determined as present or not present by a location confirmation means of the system and an offer being issued dependent on the number of group members present, subsequent offers also being issued periodically during the attendance of the group or part thereof dependent on the number of group members present each time an offer is issued, an issued offer being presented to the vendor who initiates an offer validation means by interacting with the mobile device of a user after which, should the offer be valid, the vendor applies the offer to the sale of good and/or services being purchased by the user.

The invention will now be described with reference to the accompanying drawing, which shows by way of example only one embodiments of an apparatus in accordance with the invention. In the drawings;

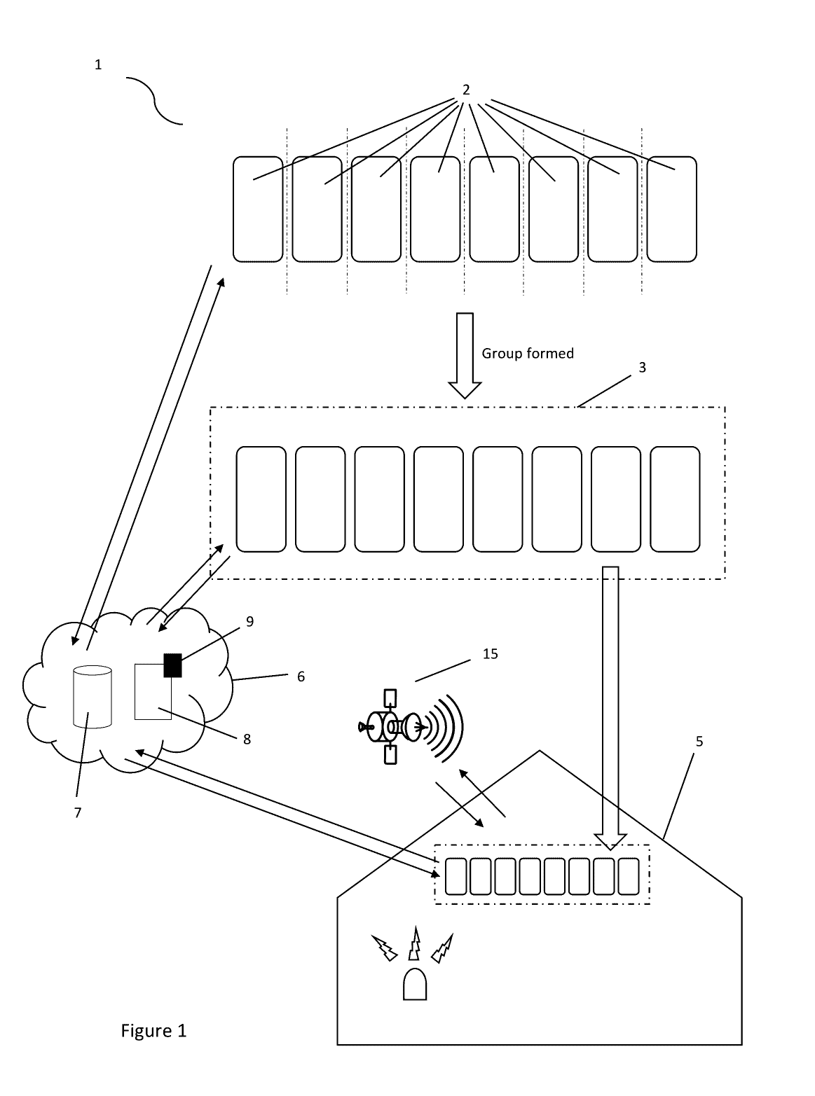

FIG. 1 is a schematic representation of the system for monitoring and communicating with groups;

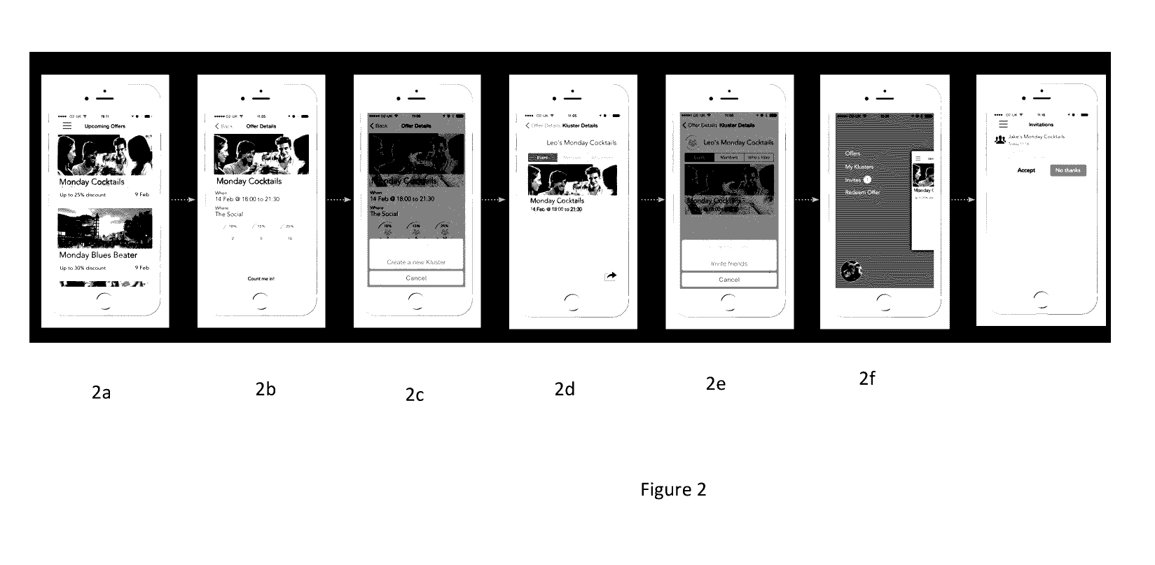

FIG. 2 shows the system in operation from the point of group formation up to but not including attendance at a business, event, or venue; and

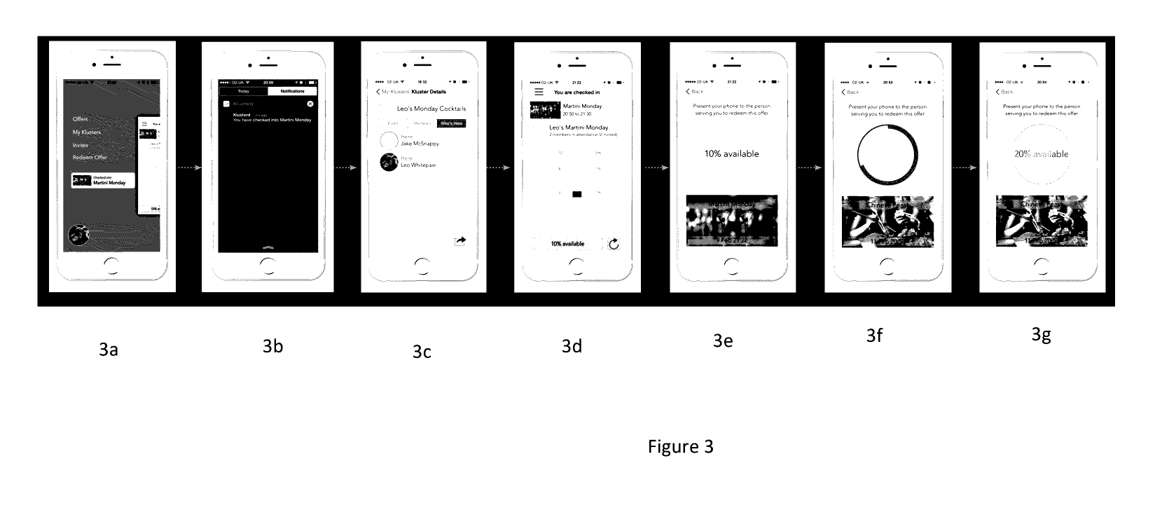

FIG. 3 shows the system in operation once a group or part thereof is in attendance at a business, event, or venue.

A system for monitoring/confirming the location of and communicating with a group of user devices or individual members thereof is generally represented by reference numeral 1. The system 1 comprises a mobile application or website executable on a mobile device 2 such as a smartphone. The mobile application enables users to associate mobile devices to form groups 3 of such devices. The system 1 also has a location confirmation member in the form of a Bluetooth low energy beacon and/or sonic signal beacon 4 and/or GPS system 15 for determining which mobile devices 2 associated with a formed group 3 are present in a pre-defined location or area 5, and given this information communicates collectively or individually with those mobile devices 2 which are associated with a formed group 3 and have been determined as present in the pre-defined location or area 5 at the time of said communication. GPS may be utilized as the primary location confirmation member or to support or back-up the location confirmation member 4, 15.

While a mobile device 2 is utilized when at a predefined location or area 5, any device can be utilized to interact with the mobile application or website prior to this point, for example users may utilize the website to create groups on a computer.

The presence of each mobile device 2 in the pre-defined location or area 5 is periodically confirmed by communication between the mobile device 2 in question and location confirmation member 4 at regular time intervals. In this way, communication can be tailored based on accurate attendance information. A mobile device 2, upon receipt of a signal from the location confirming member 4, 15, is confirmed as present in the pre-defined location or area 5.

The mobile application is in operable communication with a database 7 for storing information with regards to groups 3 a mobile device 2 is associated with and presence in a pre-defined location or area 5. The mobile application is also in operable communication with a storage member 8 having a software program executable thereon via a processor 9, or most preferably, the database and software program are located in the cloud 6. The software program decides which communication a particular mobile device 2 or group 3 thereof will receive based on information stored in the database 7.

The location confirmation member 4, 15 can be configured to only confirm the presence of mobile devices 2 within a pre-defined area 5 around said location confirmation member 4 most likely this area 5 would comprise the interior of a building.

The content of the communication with a group of mobile devices 3 or individual member 2 thereof ill be dependent on the number of mobile devices 2 of said associated group 3 of mobile devices 2 which are present in the pre-defined location or area 5. The communication takes the form of a discount or offer, the value of which increases depending on the number of mobile devices 2 of said associated group 3 of mobile devices 2 which are present in the pre-defined location or area 5.

The group of mobile devices 3 or individual member mobile devices 2 can receive their offer or discount via any suitable message system such as a message system built into the mobile application, by email, by social network messaging, by mobile device notification, by a message or document transmitted by the location confirmation member 4, or by any other form of suitable messaging medium.

In use, users will form a group 3 by grouping their respective mobile devices 2 and register their intent to attend a venue 5 at some point in the future, information on the group 3, it's members 2, and venue location 5 being stored in the database 7. Upon attending the venue 5 each user 2 is confirmed in attendance by the location confirmation member 4 and receives a offer or discount the value of which will be dependent on the group 3 size confirmed present. The user can then use said discount or offer on the product or service offered at the venue 5 in question. The number of group members 2 of a particular group 3 in attendance will be monitored periodically and discounts or offers issued accordingly so that large early attendance of a particular group 3 followed by a significant drop in the attendance of a particular group 3 is accounted for.

The location confirmation member 4 in the embodiment shown in FIG. 1 is a combination of a Bluetooth beacon 4 and a GPS system 15, however it is to be understood that even in this embodiment only one of these is required to confirm location.

Referring now to FIGS. 2 and 3, in the specific embodiments shown the group of user devices is a group of smartphones or other mobile devices having a mobile application executable thereon and enabling users to associate individual user devices to form groups of user devices and associate said group with a business, event, or venue who intend to communicate with and/or provide offers to users who attend their business, event, or venue as a group.

The mobile application permits businesses, events, or venues who intend to communicate with and/or provide offers to users who attend their business, event, or venue as a group to list their businesses, events, or venues on the mobile application such that users can search and/or view said businesses, events, or venues and their associated offers (see FIG. 2a). The businesses, events, or venues can specify the offer or offers available, the time of the event, and any other relevant information (see FIG. 2b)

Once a user has located a business, event, or venue that they wish to attend, they may create a group and associate said group with the business, event, or venue, and invite other users to join the group (see FIGS. 3c to 3g). Any group member may invite additional users to join the group. The location confirmation means is one or both of GPS and Bluetooth low energy beacon, these technologies working alone or together to determine which user devices associated with a formed group are present at a the business, event, or venue associated with the group and confirmation of attendance is viewable by a user from a screen within the mobile application FIG. 3a). The mobile application displays an automatically generated offer, the value of which is based on the number of user devices associated with a formed group who are confirmed as currently present at business, event, or venue (see FIG. 3d and FIG. 3e). The mobile application also presents other information to a user including the other members of the group who are present (see FIG. 3c).

The system periodically assesses the number of user devices associated with a formed group who are confirmed as currently present at the business, event, or venue and generates a new offer based on this information, the new offer being the same, of greater value, or of lesser value depending on whether the number of user devices associated with a formed group who are confirmed as currently present at the business, event, or venue has remained the same, increased, or decreased since the previous offer.

The system provides predefined bands of offers (see FIG. 2b and FIG. 3d) which specify different offer levels and the number of user devices associated with a formed group who are confirmed as currently present at the business, event, or venue which is required to attain a particular offer level.

Once a user receives an offer, the user presents the offer to a vendor at the business, event, or venue and the vendor presses on the screen of the mobile device initiating an animation or revealing a code or other such verification (see FIGS. 3e to 3g). The initiation of the animation or revealing of the code or other such verification means can only be carried out once per offer, or a number of times as dictated by the business, event, or venue. The vendor, once satisfied that the offer is valid, applies the offer or discount to the goods and/or services purchased by the user.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof.

1. A system for monitoring/confirming the location of and communicating with a group of user devices or individual members thereof, the system comprising a user interaction interface executable on each user device, the user interaction means enabling users to associate user devices to form groups of user devices, a location confirmation means for determining which user devices associated with a formed group are present in a pre-defined location or area, and means for communicating collectively or individually with those user devices which are associated with a formed group and have been determined as present in the pre-defined location or area at the time of said communication.

2. A System as claimed in claim 1, wherein the user device is one or more of a computer, mobile phone, tablet device, or any such device and the user interaction means is a website, a web application, a mobile application or any other such interaction means capable of allowing interaction through the user device.

3. A system as claimed in claim 1, wherein the location confirmation means employs one or any combination of GPS, Bluetooth low energy, sonic signals, or near filed communication, and wherein the presence of each user device in the pre-defined location or area is periodically confirmed by communication between the user device and location confirmation means at regular time intervals, the time intervals being adjustable.

4. A system as claimed in claim 1, wherein the user interaction means is in operable communication with a database for storing information with regards to groups a user device is associated with and presence of the user device in a pre-defined location or area, information on the group including but not limited to member information and/or location of the pre-defined location or area also being stored in the database.

5. A system as claimed in claim 1, wherein the user interaction means is in operable communication with a software program, the software program having one or more algorithms for deciding and/or controlling which communication a particular user device or group thereof will receive based on information stored in the database.

6. A system as claimed in claim 1, wherein the content of the communication with a group of user devices or individual member thereof is a discount or offer the value of which increases as the number of members of said associated group of user devices which are present in the pre-defined location or area increases.

7. A system as claimed in claim 1, wherein upon attending the venue, each user is confirmed in attendance by the location confirmation means and receives a communication, the content of which will be dependent on the group size confirmed present, the user can then use said communication to receive a discount or offer on the product or service offered at the venue in question.

8. A system as claimed in claim 1, wherein throughout a users attendance at a pre-defined location or area, they receive periodic communications should they be confirmed to be in continued attendance, the content of the communication being dependent on the group size confirmed present, the user can then use said communication to receive a discount or offer on the product or service offered at the pre-defined location or area.

9. A system as claimed in claim 1, wherein organisers of events, owners of businesses, or other such parties can list events, offers, venue information, or other such information which users can access through the user interaction means.

10. A system as claimed in claim 1, wherein organisers of events, owners of businesses, or other such parties can associate their event, business, or venue, with a pre-defined location or area such that users and groups of users of the system can be confirmed in attendance at an event, business premises or venue and users can associate their group with a listed event, business, offer, or venue.

11. A system as claimed in claim 1, wherein an initial user can form a group and invite one or more other users to join the group via the user interaction means with or without the aid of email and/or text and/or social media, members of a group being able to invite further users to join the group via the user interaction means.

12. A system as claimed in claim 1, wherein should an individual be invited to join a group and the individual does not have the application executable on their mobile device, the individual will be contacted via text (SMS message), email, or social media message and instructed to install the application on their mobile device so that they may accept an invitation to the group.

13. A system as claimed in claim 1, wherein the group of user devices is a group of smartphones or other mobile devices having a mobile application executable thereon acting as the user interaction means and enabling users to associate individual user devices to form groups of user devices and associate said group with a business, event, or venue who intend to communicate with and/or provide offers to users who attend their business, event, or venue as a group.

14. A system as claimed in claim 13, wherein the mobile application permits businesses, events, or venues who intend to communicate with and/or provide offers to users who attend their business, event, or venue as a group to list their businesses, events, or venues on the mobile application such that users can search and/or view said businesses, events, or venues and their associated offers, and wherein once a user has located a business, event, or venue that they wish to attend, they may create a group and associate said group with the business, event, or venue, and invite other to join the group, any group member also being able to invite additional users to join the group.

15. A system as claimed in claim 13, wherein the location confirmation means is one or both of GPS and Bluetooth low energy beacon, these technologies working alone or together to determine which user devices associated with a formed group are present in a pre-defined location or area, the predefined location or area being associated with a business, event, or venue who intend to communicate with and/or provide offers to users who attend their business, event, or venue as a group.

16. A system as claimed in claim 13, wherein the means for communicating collectively or individually with user devices which are associated with a formed group and have been determined as present in the pre-defined location or area at the time of said communication is via the mobile application which displays an automatically generated offer, the value of which is based on the number of user devices associated with a formed group who are confirmed as currently present at the pre-defined location or area.

17. A system as claimed in claim 13, wherein the system periodically assesses the number of user devices associated with a formed group who are confirmed as currently present at the pre-defined location or area and generates a new offer based on this information, the new offer being the same, of greater value, or of lesser value depending on whether the number of user devices associated with a formed group who are confirmed as currently present at the pre-defined location has remained the same, increased, or decreased since the previous offer.

18. A system as claimed in claim 23, wherein the system provides predefined bands of offers which specify different offer levels and the number of user devices associated with a formed group who are confirmed as currently present at the pre-defined location which is required to attain a particular offer level.

19. A system as claimed in claim 18, wherein once a user receives an offer, the user presents the offer to a vendor at the business, event, or venue and the vendor presses on the screen of the mobile device initiating an animation or revealing a code or other such verification, and wherein the initiation of the animation or revealing of the code or other such verification means can only be carried out once per offer, or a number of times as dictated by the business, event, or venue.

20. A method preformed by a system for monitoring/confirming the location of and communicating with a group of user devices or individual members thereof, the user devices being mobile devices having a mobile application executable thereon, the method comprising a user forming a group, and inviting other users to join the group, any invited user who joins the group may also invite additional users to join the group, the group being associated with a business, event, or venue who intend to communicate with and/or provide offers to users who attend their business, event, or venue as a group either whilst forming the group or thereafter, the businesses, events, and/or venues being viewable and/or searchable by users via the mobile application, the group or part thereof attending the business, event, or venue and each member of the group being determined as present or not present by a location confirmation means of the system and an offer being issued dependent on the number of group members present, subsequent offers also being issued periodically during the attendance of the group or part thereof dependent on the number of group members present each time an offer is issued, an issued offer being presented to the vendor who initiates an offer validation means by interacting with the mobile device of a user after which, should the offer be valid, the vendor applies the offer to the sale of good and/or services being purchased by the user.
